(19) United States
(12) Patent Application Publication
(10) Pub. No.: US 2017/0374446 A1
(43) Pub. Date: Dec. 28, 2017

(54) PROTECTIVE, SOUND ABSORBING, AND/OR DECORATIVE DEVICE FOR COVERING AND/OR COUPLING TO EARPHONES

(71) Applicant: NECTAR SOUND LABS, LLC, Lake Forest, CA (US)

(72) Inventor: Erik Devon Adams, Lake Forest, CA (US)

(21) Appl. No.: 15/631,900

(22) Filed: Jun. 23, 2017

Related U.S. Application Data
(60) Provisional application No. 62/354,625, filed on Jun. 24, 2016.

(51) Int. Cl. H04R 1/10

(52) U.S. Cl. CPC H04R 1/1016; H04R 1/1083; H04R 1/105; H04R 1/1091; H04R 1/10; H04R 2201/10

(57) ABSTRACT

Some embodiments disclose a customizable covering device for earphones. In some embodiments, the device can removably engage on to the earphones with arms of the coupling portion. A cap portion can extend from the coupling portion and allows a user to add protective, decorative, sound isolating and other additional features that are not present in conventional earphones.

### CROSS-REFERENCE TO RELATED APPLICATIONS

This application claims the benefit of U.S. Provisional Application No. 62/354,625, filed on Jun. 24, 2016 and titled “PROTECTIVE, SOUND ABSORBING, AND/OR DECORATIVE DEVICE FOR COVERING AND/OR COUPLING TO EARPHONES.” The foregoing application is hereby incorporated herein by reference in its entirety.

### BACKGROUND

### Field

The disclosure relates generally to the field of earphones, and more particularly to protective, sound absorbing, and/or decorative devices for covering and/or coupling to one or more earphone devices.

### SUMMARY

Various embodiments described herein address problems of susceptibility of earphone devices to damage and their general lack of features other than converting signals into audible sounds.

Some embodiments include a monolithic protective cap that can be configured to be removably coupled to an earphone device. The monolithic protective cap can comprise a generally circular cap portion comprising an inner surface, an outer surface, and a side wall portion, wherein the side wall portion comprises a fragment of a generally annular shape, wherein the inner surface extends from at least a fragment of one side of an circumference of the side wall portion and the outer surface extends from at least a fragment of another side of the circumference of the side wall portion, wherein the inner surface and the outer surface comprises a generally flat surface, wherein the inner surface extends from the side wall portion at a first angle measured between the side wall portion and the generally flat surface of the inner surface, wherein the first angle is greater than 45 degrees and less than 135 degrees, wherein the outer surface extends from the side wall portion at a second angle measured between the side wall portion and the generally flat surface of the outer surface, wherein the second angle is greater than 45 degrees and less than 135 degrees, and wherein the outer surface further comprises one or more graphics, wherein the inner surface comprises sound absorbing properties, thereby reducing outside noise from entering the earpiece of the earphone device and further reducing sound from the earphone device from escaping. The monolithic protective cap can further comprise a coupling portion comprising: a stem portion, wherein the stem portion extends from the cap portion at a third angle measured between the stem portion and the cap portion, wherein the third angle is greater than 135 degrees and less than 225 degrees, a first arm, wherein the first arm extends from a portion of one side of the stem and comprises a fragment of a generally annular shape, and a second arm, wherein the second arm extends from a portion of another side of the stem and comprises a fragment of a generally annular shape, wherein end of the first arm and end of the second arm form a gap, wherein the first and second arms are configured to slide onto a shaft of the earphone device in a general direction from the wire of the earphone device to the shaft of the earphone device and wherein the arms are shaped such that the arms form to the shape of the shaft of the earphone device forming a grip on the earphone device, thereby increasing friction between the first and second arms to allow for coupling between the protective device and the earphone device, wherein the first and second arms are configured to detach from the shaft of the earphone device to decrease friction between the monolithic protective cap and the earphone device to allow for easy removal and installation of the cap, and thereby preventing damage to the earpiece and the wire.

In some embodiments, the inner surface can connect to the side wall by an edge portion and the outer surface connect to the side wall by an edge portion, wherein the edge portion and the side wall forms an angle of more than 90 degrees and wherein the edge portion has a width of at most 1 cm.

In some embodiments, the cap portion is made of a sound absorbing material.

In some embodiments, the cap portion is made of a mendable material.

In some embodiments, the cap portion further comprises of one or more printed circuit boards.

In some embodiments, the cap portion further comprises of one or more electronic display modules configured to display one or more graphics.

In some embodiments, the protective device further comprises of one or more sensors configured to measure one or more physiological readings.

In some embodiments, the protective device further comprises of one or more sensors configured to collect one or more biometric data.

In some embodiments, the protective device further comprises of one or more sensors configured to measure characteristics of the music being played by the earphone device.

Some embodiments include monolithic cap configured to be removably coupled to an earphone device comprising: a cap portion comprising an inner surface, an outer surface, and a side wall portion, wherein the inner surface extends from at least a fragment of one side the side wall portion and the outer surface extends from at least a fragment of another side of the side wall portion, wherein the inner surface and the outer surface comprises a generally flat surface, wherein the inner surface extends from the side wall portion at a first angle measured between the side wall portion and the generally flat surface of the inner surface, wherein the first angle is greater than 45 degrees and less than 135 degrees, wherein the outer surface extends from the side wall portion at a second angle measured between the side wall portion and the generally flat surface of the outer surface, wherein the second angle is greater than 45 degrees and less than 135 degrees, and wherein the outer surface further comprises one or more graphics, wherein the inner surface reduces outside noise from entering the earpiece of the earphone device; and a coupling portion comprising: a stem portion, wherein the stem portion extends from the inner surface and the outer surface of the cap portion at a third angle measured between the stem portion and the inner surface and the outer surface of the cap portion, wherein the third angle is greater than 135 degrees and less than 225 degrees, a first arm, wherein the first arm extends from a portion of one side of the stem and comprises a fragment of a generally annular shape, and a second arm, wherein the second arm extends from a portion of another side of the stem and comprises a fragment of a generally annular shape, wherein end of the first arm and end of the second arm form a gap, wherein the first and second arms are configured to slide onto a shaft of the earphone device in a general direction from the wire of the earphone device to the shaft of the earphone device and wherein the arms are shaped such that the arms form to the shape of the shaft of the earphone device forming a grip on the earphone device, thereby increasing friction between the first and second arms to allow for coupling between the protective device and the earphone device, wherein the first and second arms are configured to detach from the shaft of the earphone device to decrease friction between the monolithic protective cap and the earphone device to allow for easy removal and installation of the cap, and thereby preventing damage to the earpiece and the wire.

In some embodiments, the cap portion is made of a mendable material.

In some embodiments, the cap portion can be shaped to cover the general shape of the earphone device.

In some embodiments, a mount extends from the cap portion.

In some embodiments, the mount is connected to the cap portion with a hinge.

Some embodiments include a monolithic cap configured to be removably coupled to an earphone device comprising: a generally circular cap portion comprising an inner surface, an outer surface, and a side wall portion, wherein the side wall portion comprises a fragment of a generally annular shape, wherein the inner surface extends from at least a fragment of one side of an circumference of the side wall portion and the outer surface extends from at least a fragment of another side of the circumference of the side wall portion, wherein the inner surface and the outer surface comprises a generally flat surface, wherein the inner surface extends from the side wall portion at a first angle measured between the side wall portion and the generally flat surface of the inner surface, wherein the first angle is greater than 45 degrees and less than 135 degrees, wherein the outer surface extends from the side wall portion at a second angle measured between the side wall portion and the generally flat surface of the outer surface, wherein the second angle is greater than 45 degrees and less than 135 degrees, and wherein the outer surface further comprises one or more graphics, wherein the inner surface comprises sound absorbing properties, thereby reducing outside noise from entering the earpiece of the earphone device and further reducing sound from the earphone device from escaping; a coupling portion extending from a portion of the cap portion, comprising one or more arms, wherein the arms are configured to couple to the earphone device wherein the one or more arms are configured to removably attach on to an earphone device.

In some embodiments, the one or more arms are configured to snap on to a shaft of the earphone device.

In some embodiments, the one or more arms are configured to snap on to a wire of the earphone device.

In some embodiments, the coupling portion enclose at least a portion of a wire and at least a portion of a shaft of the earphone device.

In some embodiments, the coupling portion is made of a mendable material.

In some embodiments, the one or more arms comprises of a right arm and a left arm extending from a stem, wherein the left arm and the right arm extend from the stem by a hinge.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

A better understanding of the devices and methods described herein will be appreciated upon reference to the following description in conjunction with the accompanying drawings.

FIG. 1 illustrates an example embodiment of a protective, decorative, and/or sound absorbing device engaged onto example earphones.

FIGS. 2A-H illustrates various views of an example embodiment of a protective, decorative, and/or sound absorbing device as disclosed herein.

FIG. 3A illustrates the embodiment of FIG. 2 coupled to an earphone disposed on a human ear.

FIG. 3B illustrates a side view of the example of FIG. 3A.

FIG. 4A illustrates an example embodiment of a protective, decorative, and/or sound absorbing device coupled to an earphone and forming to the shape of the earphone.

FIG. 4B illustrates a side view of the example of FIG. 4A.

FIG. 5A illustrates an example embodiment of a protective, decorative, and/or sound absorbing device wrapping over the ear.

FIG. 5B illustrate an example of a mount comprising a decorative, protective, and/or functional portion, a hinge portion, and a mount portion.

FIGS. 6A-E illustrate side views of various embodiments of a decorative, protective, and/or sound absorbing device.

FIG. 6F illustrates an example embodiment of a wire wrapped around the decorative, protective, and/or functional portion or the cap.

FIGS. 7A-B illustrate various embodiments of a protective, decorative, and/or sound absorbing device with a display.

FIG. 7C illustrates an embodiment of a graphical display of the protective, decorative, and/or sound absorbing device with LED lights.

FIG. 7D illustrates an embodiment of a blinking graphical display to warn others nearby in the evening.

FIG. 8 illustrates an example embodiment of a protective, decorative, and/or sound absorbing device communicating with a mobile computing device.

FIGS. 9A-D illustrate various configuration of the noise isolating features of an example embodiment.

### DETAILED DESCRIPTION

Earphones have become a widely popular way to enjoy music, watch movies without disturbing others, or the like. Many people carry portable earphone devices with them as well, for example when traveling on a plane, bus, train, or other means of transportation. However, when one carries around his or her earphone device, such devices can become prone to scratches and/or other types of damage. For example, if a user drops his or her earphone device or friction is caused between an earphone device and other objects, scratches can occur. Also, depending on the force exerted on the earphone device, other more serious damage to the device or to electronics thereof can also occur. The earpiece portion of earphone devices can especially be prone to such damages, as they comprise a large portion of such devices. The portion that connects the earpieces to the wires can be vulnerable to damage because wires can be pulled from the earbud during use, transport, and/or storage. One aspect of the embodiments disclosed herein provides a device for protecting the portion of the earphone that join the earpiece portion of earphones and the wire. Another aspect of the embodiments disclosed herein provides a device for protecting the earpiece portion of earphones, wherein the device can be configured to be removably, semi-permanently, and/or permanently attached and/or coupled to an earpiece portion of earphones, thereby providing a protective cover against damages.

Moreover, when using earphones, issues relating to noise seclusion can arise. For example, in some situations, unwanted outside noise can be heard by a user of an earphone device and/or earphones. Also, in certain situations, some sound produced by a user's earphone device and/or earphones can be heard by other people located nearby. Although integrated noise canceling headphone and earphone devices have been developed to address this issue, they are generally not perfect and are sold at a premium price. As such, another aspect of some embodiments disclosed herein provides a device for absorbing sound, thereby preventing unwanted outside noise from reaching an earphone user and/or preventing sound produced by earphones and/or earphones from escaping to the near vicinity.

Furthermore, many earphone devices and/or earphones being sold in the market include a logo, trademark, or other graphic identifying the manufacturer of the device. For example, the earpiece portions of many earphone devices and/or earphones include such graphics. However, some users may not wish to display such graphics. Moreover, certain users can want to display other graphics on their earphone devices and/or earphones instead. Because earphones are a part of everyday life, they can serve as accessories. Furthermore, the uneven contour of earphones and/or earphone devices makes it difficult to add personalization to them. As such, another aspect of the embodiments disclosed herein provides a device for displaying one or more other graphics on an earpiece portion of earphone devices and/or earphones as determined by a user.

Many earphones sold in the market do not have other functionality besides converting signals to audible sounds. Many existing earbuds generally do not have the capability of displaying certain lights (for example LED lights), a logo (for example, a logo that can change on a graphical user interface on the earphone device), or having user controls on the earbud. Furthermore, earphones generally do not have customizable options for attaching to the human ear. Earphones generally do not have the option to switch from open-back to closed-back.

The disclosure herein provides a protective, sound absorbing, and/or decorative device, and/or a plurality thereof, which can be attached and/or coupled to one or more earpiece portions of an earphone device. For purposes of this summary, certain aspects, advantages, and novel features of the invention are described herein. It is to be understood that not necessarily all such advantages can be achieved in accordance with any particular embodiment of the invention. Thus, for example, those skilled in the art will recognize that the invention can be embodied or carried out in a manner that achieves one advantage or group of advantages as taught herein without necessarily achieving other advantages as can be taught or suggested herein.

In some embodiments, a device as disclosed herein is configured to couple to an earphone device, such as the earphones produced by Apple and other earphone device manufacturers. In some embodiments, such a device comprises a coupling portion and a decorative, protective, and/or functional portion or cap. In some embodiments, the coupling portion comprises a snap fit coupling shaped and configured to snap around a shaft of an earbud and hold the device in a particular position with respect to the earbud through friction between the coupling portion and the shaft of the earphone. In some embodiments, the decorative, protective, and/or functional portion or cap is coupled to or integrally formed with the coupling portion and extends from one end of the coupling portion. In some embodiments, the decorative, protective, and/or functional portion or cap is positioned such that it is positioned adjacent to, covering, encapsulating, and/or the like a speaker portion of an earphone. The decorative, protective, and/or functional portion or cap can be configured to protect the speaker portion of the earbud from damage. The decorative, protective, and/or functional portion or cap can be configured to have an area for placing thereon of a graphic, design, and/or the like. In some embodiments, the coupling portion can be configured to serve decorative, protective, and/or functional purposes.

In some embodiments, the devices can comprise a color that is similar to or the same as a color of the earphones they are intended to couple to. This can be desirable, for example, to make the device blend in more. In other embodiments, the devices disclosed herein can comprise a different color that is intended to make them stand out more from the earphones they are coupled to. This can be desirable in many cases, because some manufacturers of earbuds 100 use the same color for all their earbuds. For example, some manufacturers of earbuds tend to use a white color that is not very decorative. Accordingly, it can be desirable to have a more decorative device, such as disclosed herein, that can attach to and/or form a part of the earphone to have more distinctive appearance than if a user were just wearing the earbuds alone.

### Overview

The present disclosure discloses embodiments of a protective, decorative, and/or sound absorbing device that can be coupled to earphone devices to protect the earphones, absorb and/or redirect sound from the earbuds, and/or provide a platform for adding decorative and functional aspects to the earbuds.

In some embodiments, a protective, sound absorbing, and/or decorative device, and/or a plurality thereof can be attached and/or coupled to one or more earpiece portions of an earphone device. For example, in certain embodiments, one or more devices can be configured to be attached and/or coupled to one or more earpieces of earphones to provide additional protection for the earpiece portion from damage, such as scratches, to provide an additional layer of sound absorption, and/or to provide means for displaying one or more graphics as determined by a user. The protective, decorative, and/or sound absorbing cap can provide protection for earphones that are prone to drops and physical stress of the wire.

### Example Embodiment of a Protective, Decorative, and Sound Absorbing Device

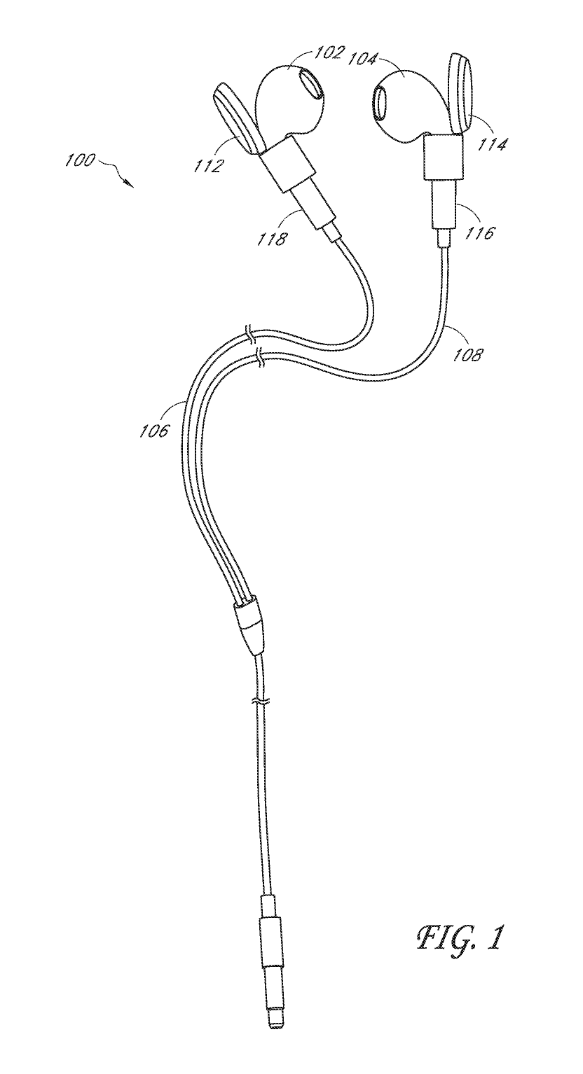

FIG. 1 illustrates an example embodiment of a protective, decorative, and/or sound absorbing device engaged on to example earphones. The earphones of FIG. 1 each comprise a speaker portion 102, 104 and a shaft 116, 118. The speaker portion 102, 104 is shaped to fit at least partially within and be held by a human ear. The shaft 116, 118 protrudes from the speaker portion 102, 104 and has a speaker wire 106, 108 protruding at its end of the shaft 116, 118.

In some embodiments, one or more protective, sound absorbing, and/or decorative devices 112, 114 can be attached and/or coupled to the one or more earpiece portions 102, 104 of an earphone device 100. In certain embodiments, the one or more earpiece portions 102, 104 of an earphone device 100 can comprise a generally circular shape and/or a circular façade.

In some embodiments, the one or more devices 112, 114 can be configured to be removably, semi-permanently, and/or permanently attached and/or coupled to the one or more earpiece portions 102, 104 of an earphone device 100. For example, in some embodiments, a protective, decorative, and/or sound absorbing device 112, 114 can be configured to be attached and/or coupled to an earpiece portion 102, 104 of an earphone device 100 via mechanical, magnetic, and/or chemical means to hold the position of the device 112, 114 substantially constant with respect to the earpiece portion 102, 104 of an earphone device 100. More specifically, in certain embodiments, a device 112, 114 can be attached and/or coupled to an earpiece portion 102, 104 of an earphone device 100 via a mechanical locking configuration. Although various embodiments disclosed herein are described as being slid onto an earpiece, various embodiments can mount in various ways. For example, some embodiments can be similar in design to the embodiments shown in the various figures, but can be sufficiently flexible that they can bend and “snap” into place on the earpiece portion.

In some embodiments, a protective, decorative, and/or sound absorbing device 112, 114 can be configured to be slid onto an earpiece portion 102, 104 of an earphone device 100 from one or more directions. For example, a device 112, 114 can be configured to be slid down onto an earpiece portion 102, 104 of an earphone device in a general direction from top of the earpiece 102 to a bottom end of the earpiece portion 102, 104. Similarly, a device 112, 114 can be configured to be slid up onto an earpiece portion 102, 104 of an earphone device 100 in a general direction from the wire to the shaft of the earpiece.

In other embodiments, the device 112, 114 can be configured to snap onto an earpiece portion 102, 104 of an earphone device 100, whereby the coupling portion can be configured to snap onto one or more existing, pre-existing, and/or newly formed shaft and/or other aspect of the exterior surface of an earpiece portion 102 104. In other embodiments, a device 112, 114 can be stuck onto and/or attached and/or coupled to an earpiece portion 102, 104 of an earphone device 100 via one or more chemical adhesives or glue.

In some embodiments, the one or more devices 112, 114 configured to be coupled to an earphone device 100 or a portion thereof can be made from a material configured to provide a protective layer for the earpiece portion 102, 104. For example, in some embodiments, the device 112, 114 can provide some protection for the earpiece portions 102, 104 from physical damage, such as scratches or dents, water damage, and/or damage resulting from electromagnetic waves. In certain embodiments, the device 112, 114 or a portion thereof can be made from a plastic, metallic, rubber, wood, leather, copper, gloss, snake leather, and/or waterproof, sound absorbing, soundproof, sound reflecting, and/or electromagnetic wave insulating material. The choice of non-conductive material like plastic, rubber, and wood can be advantageous because the device can protect frayed or damaged wires from outside interference. In certain embodiments, the device 112, 114 or a portion thereof can be made of a flexible material as to allow easy installation and/or removal. In some embodiments, the device 112, 114 or a portion thereof can be made a rigid or substantially rigid material.

In certain embodiments, the one or more devices 112, 114 configured to be coupled to an earphone device 100 can comprise a decorative, protective, and/or functional portion or cap. For example, the decorative, protective, and/or functional portion or cap can comprise a generally circular, generally elliptical, generally rectangular, and/or generally square shape. In some embodiments, the decorative, protective, and/or functional portion or cap can comprise one or more surfaces. For example, the protective, decorative, and/or sound absorbing device 112, 114 can comprise an inner surface and an outer surface. The inner surface or a portion thereof can be configured to face and/or come into contact with the earpiece portion 102, 104.

In certain embodiments, the device 112, 114 can be configured such that a layer of air (for example, an air gap) is formed between the inner surface or a portion thereof and an exterior surface of an earpiece portion 102, 104.

Such layer of air can provide, in some embodiments, a layer of soundproofing, buffer for protection of the earpiece portion 102, 104, and/or decrease friction between the earpiece portion 102, 104 and the cap 112, 114 as to allow for easy removal and/or installation of the one or more caps 112, 114 onto the one or more earpiece portions 102, 104 and/or preventing damage to the earpiece portion 102, 104 while removing and/or installing the one or more caps 112, 114. In some embodiments, including such an air gap can be desirable to, for example, enable optional insertion of an accessory therein. For example, in some embodiments, a layer of sound deadening material can be shaped or configured to be positioned within such an air gap to help decrease an amount of sound being emitted from the earphones to the external environment.

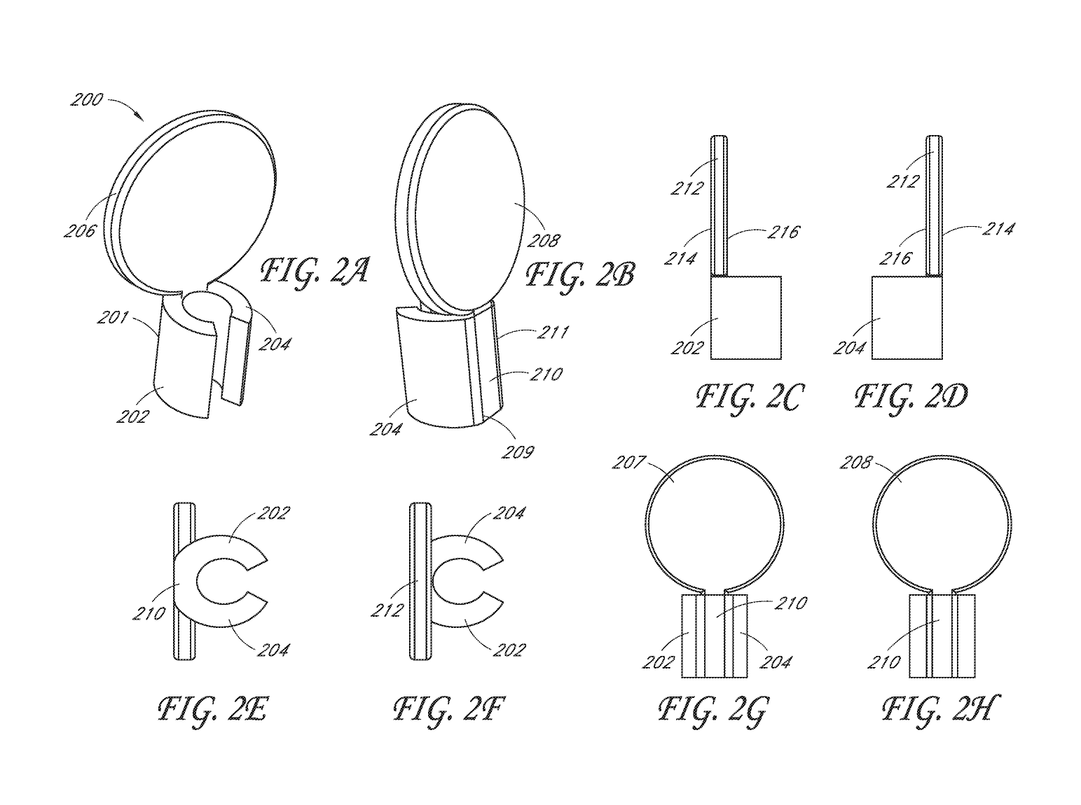

FIGS. 2A-H illustrates various views of an embodiment of an earphone cap as disclosed herein. FIGS. 2A-B illustrate example perspective views of a protective, sound absorbing, and/or decorative device 200. FIG. 2C illustrates a left view, and FIG. 2D illustrates a right view of the protective, sound absorbing, and/or decorative device 200. FIG. 2E illustrates a bottom view and FIG. 2F illustrates a top view of the protective, sound absorbing, and/or decorative device 200. FIG. 2G illustrates a front view and FIG. 2H illustrates a back view of the protective, sound absorbing, and/or decorative device 200. This embodiment of protective, sound absorbing, and/or decorative device comprises two primary portions, namely a coupling portion 201 and a decorative, protective, and/or functional portion or cap 206. The coupling portion 201 is shaped and configured to attach to the shaft portion 116, 118 of an earphone device 100, as exemplified in FIG. 1. The coupling portion 201 can include the stem portion 210, the left arm 202, and the right arm 204. In this embodiment, the coupling portion 201 comprises an elongated C-shaped snap fit mechanism. Accordingly, the coupling portion 201 can be placed adjacent the shaft 116, 118 of an earbud, and snapped into place over the shaft by a user. In some embodiments, the coupling portion 201 can be placed onto the wire 106, 108 of the earphones 100. Other embodiments can utilize other coupling methods, such as, for example, adhesive, magnetics, and/or the like. Further, although this embodiment comprises an integrally molded assembly that has a certain amount of flex (i.e. elastic bending) to the material to enable the snap fit, various other embodiments can utilize other mechanisms. For example, the coupling portion 201 can comprise relatively rigid arms that do not flex enough for a snap fit, but that can be hinged and biased to a closed position with a spring to enable the snap fit (for example, similar to a hinged clamshell hair clip).

In some embodiments, as shown in FIGS. 2A-H, a protective, sound absorbing, and/or decorative cap 200 can comprise one or more decorative, protective, and/or functional portions or caps 206 and one or more coupling portions. In certain embodiments, the one or more decorative, protective, and/or functional portions or caps 206 and coupling portions 201 are formed as a single piece, as to create a cap 200 that is monolithic. In other embodiments, the one or more decorative, protective, and/or functional portions or caps 206, coupling portions 201, and/or any portion(s) thereof and/or any combination thereof are formed separately first and then attached together to create a single device 200 (or can be assembled together during production of one or more portion, such as by using insert molding and/or the like).

Decorative, Protective, and/or Functional Portion(s) or Cap

In some embodiments, the decorative, protective, and/or functional portion or cap 206 extends from a top surface of the coupling portion 201. The decorative, protective, and/or functional portion 206 can be positioned adjacent to and/or substantially near at least a portion of the speaker portion 102, 104 of the earbud 100 when the coupling portion 206 is snapped into place over the shaft 116, 118 of the earbud 100. For example, the decorative, protective, and/or functional portion 206 or cap can be positioned near the back of the speaker portion 102, 104 as shown in FIG. 1.

In some embodiments, the decorative, protective, and/or functional portion or cap 206 comprises a generally circular shape. In this embodiment, the decorative, protective, and/or functional portion 206 is a generally disk-shaped member, however other embodiments can take a different shape. For example, instead of being relatively flat, some embodiments can include a decorative, protective, and/or functional portion or cap 206 that includes a shape that at least partially conforms to the shape of the speaker portion 102, 104 of the earbud. In some embodiments, the back of the speaker section 102, 104 may not be flat but curved. The decorative, protective, and/or functional portion or cap 206 can include malleable material that can form to the shape of the back for the speaker section 102, 104.

In other embodiments, the decorative, protective, and/or functional portion or cap 206 can comprise a substantially rectangular, substantially square, substantially triangular, substantially pentagonal, substantially hexagonal, and/or any other shape. In certain embodiments, the decorative, protective, and/or functional portion or cap 206 can comprise a shape that is substantially equal to and/or is a smaller or larger version of a substantially same shape as an earpiece portion of an earphone.

In certain embodiments, the decorative, protective, and/or functional portion or cap 206 can comprise one or more surfaces. For example, in certain embodiments, the decorative, protective, and/or functional portion or cap 206 can comprise an inner surface 207 and an outer surface 208. The inner surface 207 can be configured to oppositely face an exterior surface of an earpiece portion 102, 104 of an earphone device. In some embodiments, the inner surface 207 of a decorative, protective, and/or functional portion or cap 206 or a portion thereof can come into contact with an outer surface of an earpiece of an earphone when coupled to the earphone device 100. The outer surface 208 of the decorative, protective, and/or functional portion or cap 206, in certain embodiments, can comprise one or more decorative artwork and/or other graphical display as discussed.

In some embodiments, the outer surface 208 and inner surface 207 can be made of different materials. For example, in certain embodiments, the inner surface 207 and/or outer surface 208 can be made of a sound absorbing material to block sound leakage from the earphones. In some embodiments, only the outer surface 208 can be made of a reflective material to increase visibility of the device. For example, the outer surface 208 can reflect light such that an automobile driving at night can visibly see the light reflecting from the outer surface 208.

In some embodiments, the radius of a circular inner surface 207 and/or outer surface 208 of a decorative, protective, and/or functional portion or cap 206 can be about 0.1 cm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 3.1 cm, about 3.2 cm, about 3.3 cm, about 3.4 cm, about 3.5 cm, about 3.6 cm, about 3.7 cm, about 3.8 cm, about 3.9 cm, about 4 cm, about 4.1 cm, about 4.2 cm, about 4.3 cm, about 4.4 cm, about 4.5 cm, about 4.6 cm, about 4.7 cm, about 4.8 cm, about 4.9 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, about 20 cm, and/or within a range defined by two of the aforementioned values. In some embodiments, the radius of the inner surface 207 can be different from the radius of the outer surface 208. For example, the radius of the inner surface 207 can be smaller than the radius of the outer surface 208 thus covering the inner surface from view and/or allowing for a larger outer surface 208 while including a radius for the inner surface 207 to fit on the earbud 100.

In certain embodiments, a thickness of the decorative, protective, and/or functional portion or cap 206 or distance between an outer surface 208 and inner surface 207 thereof can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values. In some embodiments, a ratio between a radius of an inner and/or outer surface of a cap portion 206 and a thickness thereof can be calculated by combining any of the aforementioned values.

In certain embodiments, one or more edge portions 214, 216 further extend from the one or more surfaces 206, 208 and connect to the side wall 212. For example, in some embodiments, a decorative, protective, and/or functional portion or cap 206 can comprise one, two, three, four, five, six, seven, eight, nine, or ten edge portions 214, 216. In certain embodiments, one or more edge portions 214, 216 can extend and/or protrude from one or more surfaces 206, 208 at an angle. An angle measured from the outer surface of the one or more edge portions 214, 216 and the outer surface of the side wall 212 can be about 0°, about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or within a range defined by any of the two above-identified values. In some embodiments, the side wall portion 212 comprises a generally annular shape. The inner surface 207 can extend from at least a fragment of one side of the circumference of the side wall 212. The outer surface 208 can extend from at least a fragment of another side of the circumference of the side wall 212.

The inner surface 207 can extend from one side of the side wall 212 at an angle, such as an angle greater than 45° and less than 135°. An angle measured from the inner surface 207 and the side wall 212 can be about 0°, about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or within a range defined by any of the two above-identified values.

The outer surface 208 can extend from another side of the side wall 212 at an angle, such as an angle greater than 45° and less than 135°. An angle measured from the outer surface 208 and the side wall 212 can be about 0°, about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or within a range defined by any of the two above-identified values.

In certain embodiments, the width of one or more edge portions 214, 216 can be about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values.

In certain embodiments, the width of side wall portion 212 can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values. In certain embodiments, the decorative, protective, and/or functional portion or cap 206 and the coupling portion 201 connect at a portion of the side wall 212.

### Coupling Portion(s)

In some embodiments, the coupling portion 201 extends from the bottom of the decorative, protective, and/or functional portion or cap 206. The coupling portion 201 can be comprised of a stem portion 210, a left arm 202, and a right arm 204. In some embodiments, the coupling portion 201 is positioned such that it will be positioned adjacent to and/or covering at least a portion of the shaft 116, 118 of the earphone 100. In other embodiments, the coupling portion 201 is positioned such that it will be positioned adjacent to and/or covering at least a portion of the earphone 100 where the shaft 116, 118 and the wire 106, 108 connect when the coupling portion 201 is snapped into place over the shaft 106, 108 of the earphone. In other embodiments, the coupling portion 201 can couple with the wire 106, 108. In some embodiments, the coupling portion 201 can couple with both the wire 106, 108 and the shaft 116, 118.

In some embodiments, the height of the coupling portion 201 can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values.

In some embodiments, the height of the coupling portion 201 can be adjusted. For example, if the shaft 116, 118 of the earbud 100 is long, the height of the coupling portion 201 can be adjusted to match the length of the shaft 116, 118. In some embodiments, the wires can be prone to breaking. The height of the coupling portion 201 can be adjusted to couple to the wire 106, 108 as well as the shaft 116, 118.

In some embodiments, the coupling portion 201 can couple to the wire 106, 108. In some embodiments, the coupling portion 201 can couple to both the wire 106, 108 and the shaft 116, 118. The coupling portion 201 can couple to the wire 106, 108 and create friction between the coupling portion 201 and the wire 106, 108. During use and storage of the earbud, the wire 106, 108 can sway back and forth and/or get pulled or pushed in. Because the wire can be prone to break, especially close to the shaft 116, 118, the coupling portion 201 can help mitigate the damage by providing additional support for the wire 106, 108.

In some embodiments, the coupling portion 201 can couple to both the shaft 116, 118 and the wire 106, 108. The coupling portion 201 can then provide friction between the coupling portion 201 and the shaft 116, 118 as well as friction between the coupling portion 201 and the wire 106, 108. This can provide support for the wire 106, 108 to align with the shaft 116, 118 to mitigate the stress on the wire 106, 108 as the wire 106, 108 can be moved around and disalign from the shaft 116, 118.

As shown in the example embodiments of FIGS. 2A-H, the left arm 202 and the right arm 204 include a circular arc shape. In certain embodiments, radius of the arc for the left arm 202 and the right arm 204 can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values.

In some embodiments, the left arm 202 and right arm 204 are connected and/or are part of a single arm. In some embodiments, the left arm 202 and the right arm 204 form a different shape, such as a rectangular shape or an oval shape, and/or can be made of a malleable material such as to form to the shape of the wire 106, 108 and/or the shaft 116, 118. The left arm 202 and right arm 204 can extend from a portion of the stem 210.

In some embodiments, the coupling portion 201 includes one or more arms that couple to the earbud. The one or more arms can couple to the shaft and/or the wire of the earbud.

In certain embodiments, a thickness of the coupling portion 201 can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values.

In certain embodiments, a gap is formed between the left arm 202 and the right arm 204. In some embodiments, a width of the gap of the left arm 202 and the right arm 204 can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values.

As shown in FIGS. 2A-H, in this example embodiment, the stem portion 210, the left arm 202, and the right arm 204 are monolithic. In other embodiment, the left arm 202 and right arm 204 can be attached to the stem portion 210 by a flexible bonding material or a hinge and spring.

In certain embodiments, the stem 210 includes a flat section. The width of the flat section can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values. In some embodiments, the length of the flat section can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values. Such a flat surface can help with stability of the cap when the cap is placed on a flat surface.

In certain embodiments, the stem 210 can conform to the shape of the first and/or second arms 202, 204. For example, the arms 202, 204 can include a round arc, and the stem can also be arced in the same radius. In certain embodiments, radius of the arc for the stem 210 can be about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values.

In certain embodiments, the arms 202, 204 can be connected to the stem 210 by edge portions 209, 211. In certain embodiments, one or more edge portions 209, 211 can extend and/or protrude from stem 210 at an angle. An angle measured from the outer surface of the edge portion and the outer surface of the stem 210 can be about 0°, about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or within a range defined by any of the two above-identified values.

The stem 210 can extend from the inner surface 207. An angle measured from the stem 210 and the inner surface 207 can be about 90°, about 100°, about 110°, about 120°, about 130°, about 140°, about 150°, about 160°, about 170°, about 180°, about 190°, about 200°, about 210°, about 220°, about 230°, about 240°, about 250°, about 260°, about 270°, or within a range defined by any of the two above-identified values.

The stem 210 can extend from the outer surface 208. An angle measured from the stem 210 and the outer surface 208 can be about 90°, about 100°, about 110°, about 120°, about 130°, about 140°, about 150°, about 160°, about 170°, about 180°, about 190°, about 200°, about 210°, about 220°, about 230°, about 240°, about 250°, about 260°, about 270°, or within a range defined by any of the two above-identified values.

In certain embodiments, the width of one or more edge portions 209, 211 can be about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 4 cm, about 5 cm, about 6 cm, about 7 cm, about 8 cm, about 9 cm, about 10 cm, and/or within a range defined by any two of the aforementioned values.

### A Flat Cap and Earphone on a Human Ear

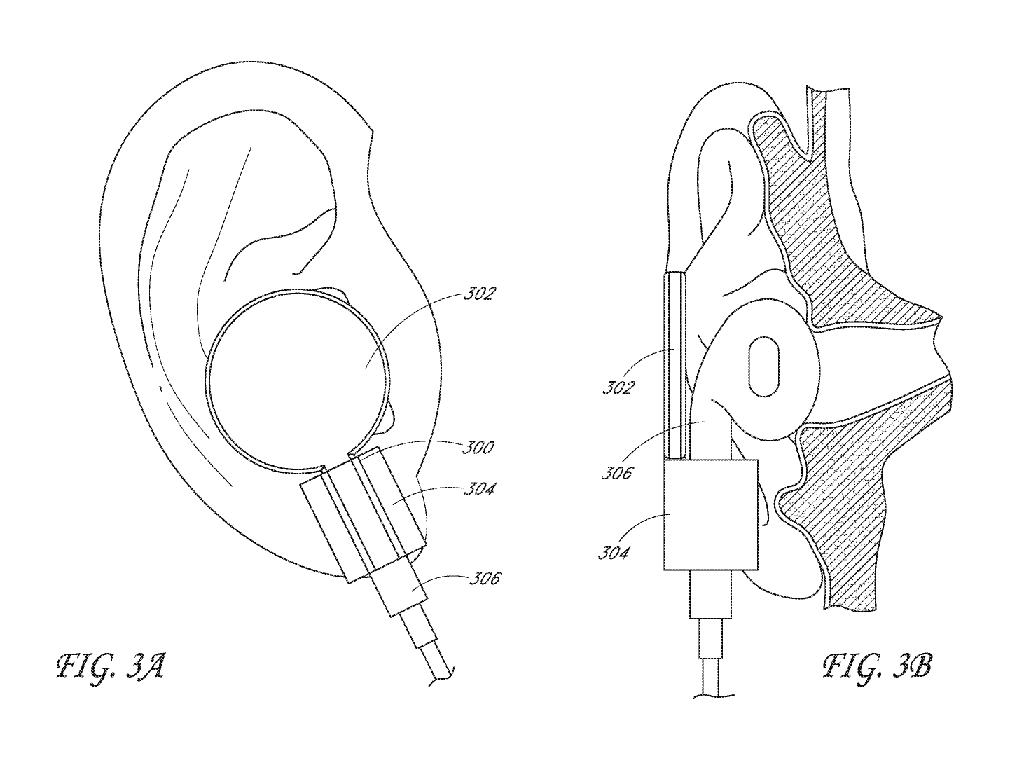

FIG. 3A illustrates an example embodiment 300 engaged on to an earphone device 306 that is inserted into the ear. In FIG. 3A, the coupling portion 304 is coupled to the earphone device 306. In FIG. 3A, the decorative, protective, and/or functional portion or cap 302 is the size of general speaker portions of the earphone and round. The cap 302 can be configured to not come in contact with the ear.

FIG. 3B illustrates a side view of the example of FIG. 3A. The example in FIG. 3B illustrates a flat inner surface 207 of the decorative, protective, and/or functional portion or cap 302. In some embodiments, the flat inner surface 207 of the decorative, protective, and/or functional portion or cap 302 can extend to the speaker section 102, 104.

### A Malleable Cap and Earphone on a Human Ear

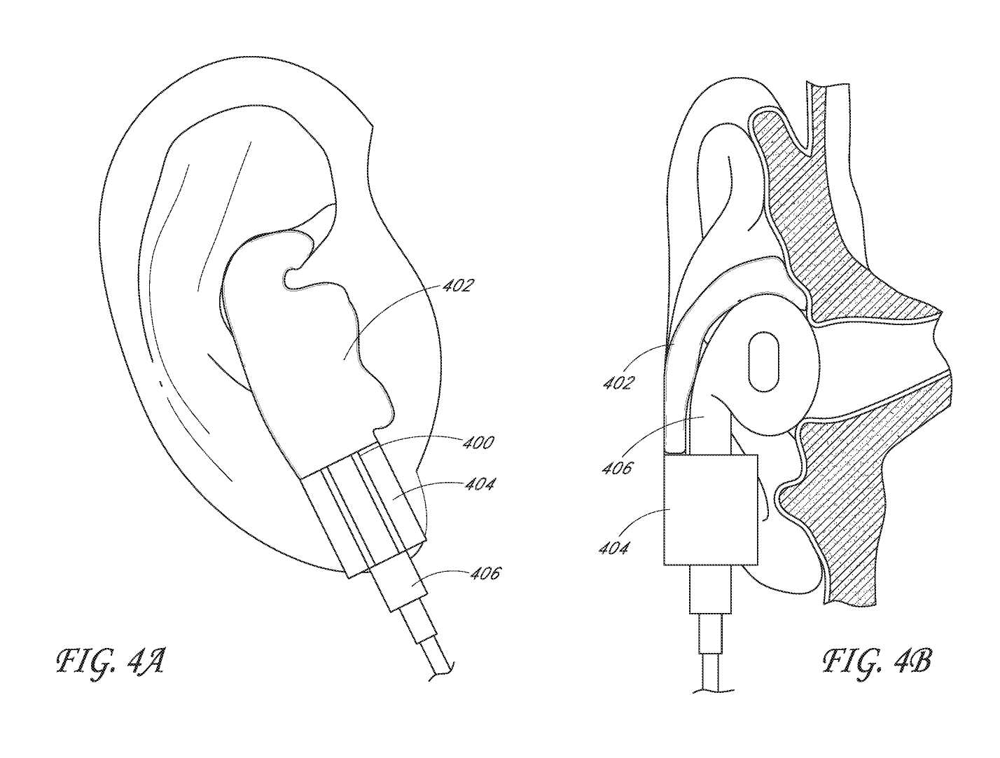

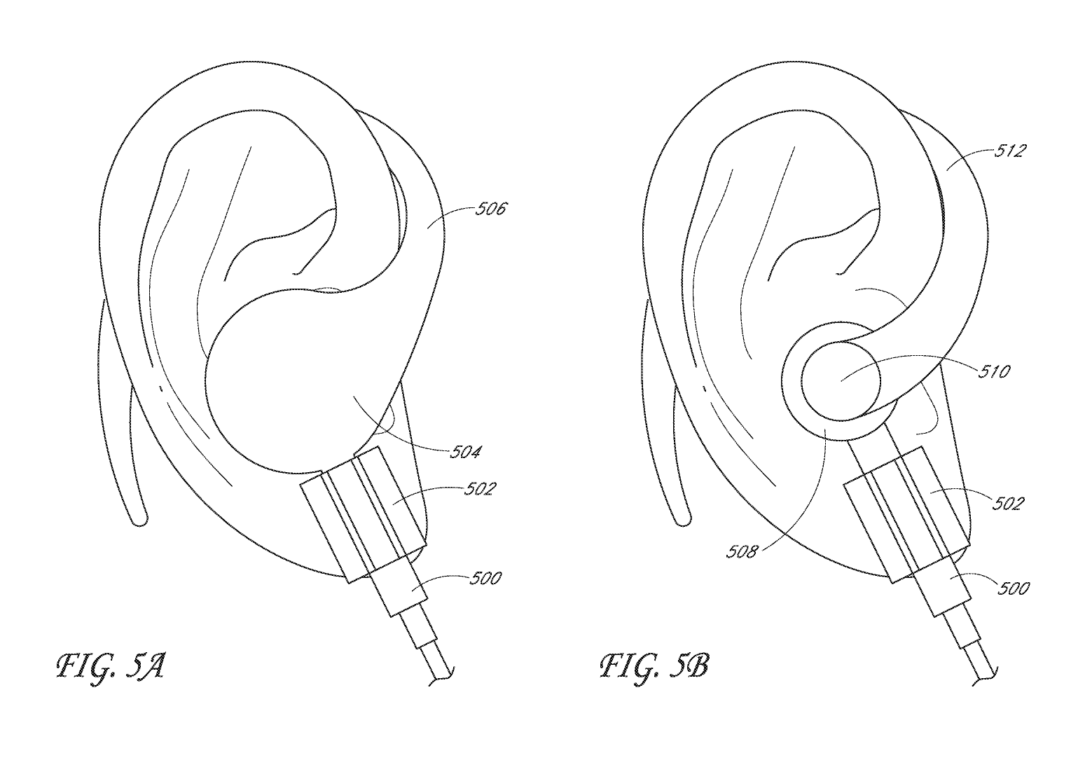

FIG. 4A illustrates an example embodiment 400 engaged on to an earphone device 406 that is inserted into the ear. In FIG. 4A, the coupling portion 404 is coupled to the earphone device 406. In FIG. 4A, the decorative, protective, and/or functional portion or cap 402 is made of a malleable material (for example, silicon) that can be shaped to fit the shape of the user's ear. FIG. 4B illustrates a side view of the example of FIG. 4A. The decorative, protective, and/or functional portion or cap 402 can come in contact with the ear will help the earphones stay in the ear. In some embodiments, the decorative, protective, and/or functional portion or cap 402 can be malleable such that decorative, protective, and/or functional portion or cap 402 can at least partially form to the shape of the speaker section 102, 104 and/or the shaft portion 116, 118.

In some embodiments, the decorative, protective, and/or functional portion or cap 402 can be made of a partially adhesive material. Such an adhesive material can help keep the decorative, protective, and/or functional portion or cap 402 attached to the speaker section 102, 104 of the earbud 406 and/or to the cavity of the human ear.

### Mount Extension for Cap Portion

FIG. 5A illustrates an example embodiment engaged on to an earphone device 500 that is inserted into the ear. The coupling portion 502 is coupled to the earphone device 500. The decorative, protective, and/or functional portion or cap 504 can include a mount 506 extending from the outer surface. In some embodiments, the mount 506 can be made of a flexible material so that it can be shaped around the ear.

FIG. 5B illustrates an example of a mount 512 comprising a decorative, protective, and/or functional portion or cap 508, a hinge portion 510, and a mount portion 512. Such a configuration can allow customization of the engagement of the mount 512 with the ear. The mount 512 can be adjusted in length and width to fit over the top of the ear. Such customization of the ear piece can allow for improved performance for attaching to the ear (for example, improved performance while running). In some embodiments, the hinge 510 can be in a different location (such as on the mount 512).

### Side Views of Various Embodiments

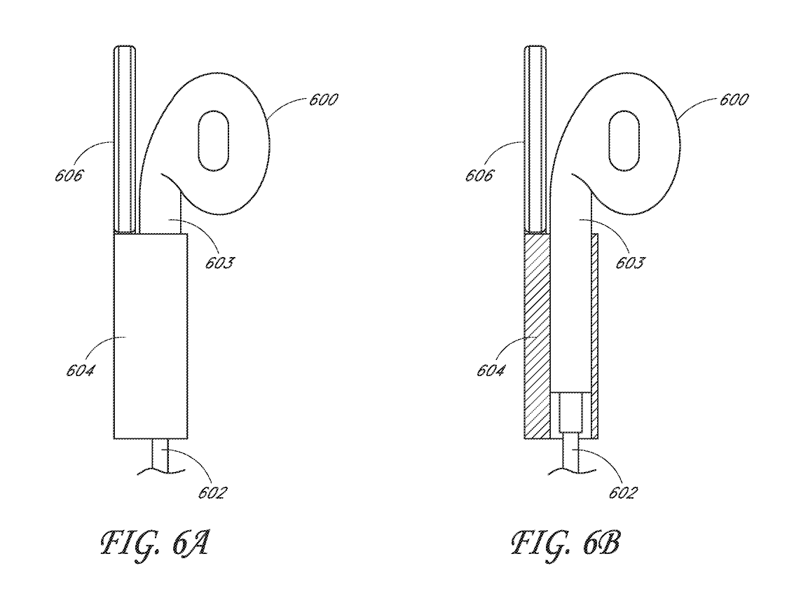

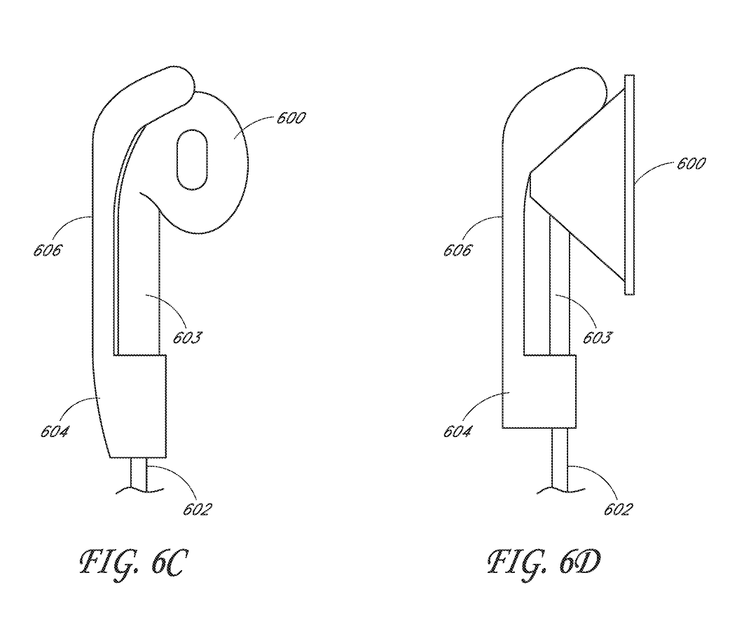

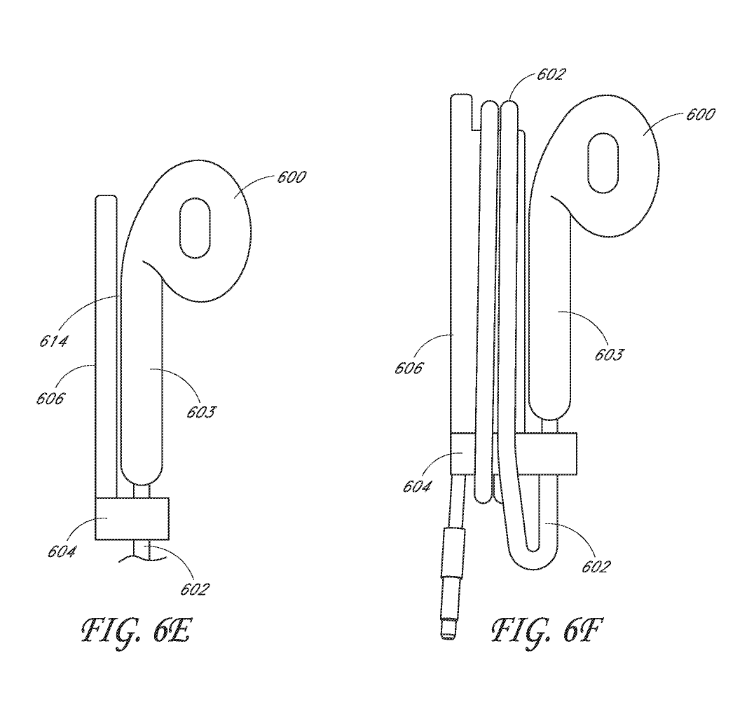

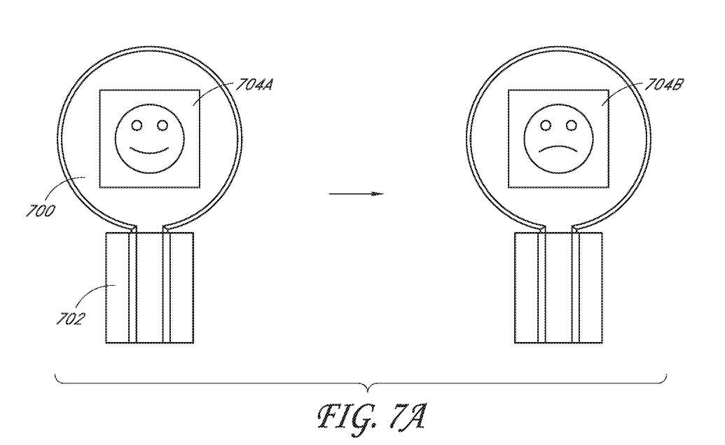

FIGS. 6A-F illustrate side views of various embodiments of a protective, decorative, and/or sound absorbing device. FIGS. 6A-B illustrate example embodiments where the coupling portion 604 serves a protective function. FIG. 6A illustrates an example of a flat protective, decorative, and/or sound absorbing device 606 with a coupling portion 604. FIG. 6B illustrates a cross-sectional view of FIG. 6A. In this embodiment, as shown in cross-section 6B, the coupling portion 604 extends at least to the wire 602 and encloses a portion of the earphone where the wire 602 and the earphone 600 connect. The coupling portion 604 can couple to both the wire 602 and the shaft 603 of the earphone 600. The coupling portion 604 can comprise more than one way of coupling. For example, the coupling portion 604 can comprise one way of coupling to the shaft 603 of the earbud and another way of coupling to the wire 602.

In the example embodiment shown in FIGS. 6A-B, the coupling portion 604 maintains the same width throughout. In other embodiments, the coupling portion 604 can be of different widths. For example, the coupling portion 604 can taper into a smaller width to enclose the wire 602 with a smaller width than the coupling portion encloses the shaft 603 of the earphone.

FIGS. 6C-6D illustrate an example embodiment where the decorative, protective, and/or functional portion or cap 606 is shaped to enclose the speaker portion of the earphone 600. The decorative, protective, and/or functional portion or cap 606 can be made of a flexible material. For example, the flexible material can allow the user to mend the shape. In some embodiments, the speaker section of the earphone 600 can be pressed against the flexible material of the decorative, protective, and/or functional portion or cap 606 and the flexible material of the decorative, protective, and/or functional portion or cap 606 can mend to the shape of the speaker section of the earphone 600. The decorative, protective, and/or functional portion or cap 606 can be shaped to fit over various types of earphones as exemplified by the earphone 600 illustrated in FIG. 6C and FIG. 6D. This allows the user to use the same decorative, protective, and/or functional portion or cap 606 for various shapes and sizes of earphones and avoid the need for caps specifically made for a particular model of earphones.

FIG. 6E illustrates an example embodiment where the coupling portion 604 is engaged on to the wire 602 of the earphone device 600. In this example embodiment, the cap is configured such that a layer of air (for example, an air gap) 614 is formed between the inner surface of the decorative, protective, and/or functional portion or cap 606 or a portion thereof and an exterior surface of an earphone 600. In other embodiments, the cap 606 can be adjacent to the earphone 600. In some embodiments, the decorative, protective, and/or functional portion or cap 606 can be coupled to an earphone device via one or more adhesives (for example adhesive chemical or glue). Because wire sizes conform typically to a standard size rather than the different shape of earphone devices, this embodiment allows the user to use the same cap for various earphones.

FIG. 6F illustrates an example embodiment of the decorative, protective, and/or functional portion device whereby the wire 602 can be wrapped around the decorative, protective, and/or functional portion or cap 606 for storage. This type of structure can provide the user with a way of storing and/or changing the length of the wire 602.

### Graphical User Interface

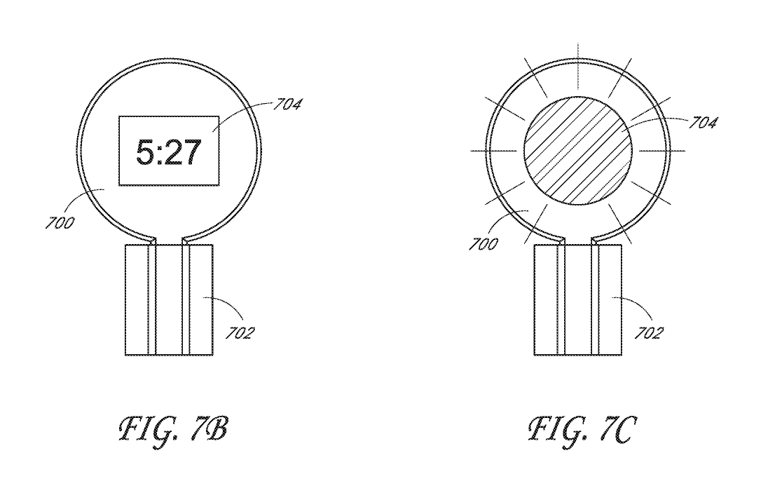

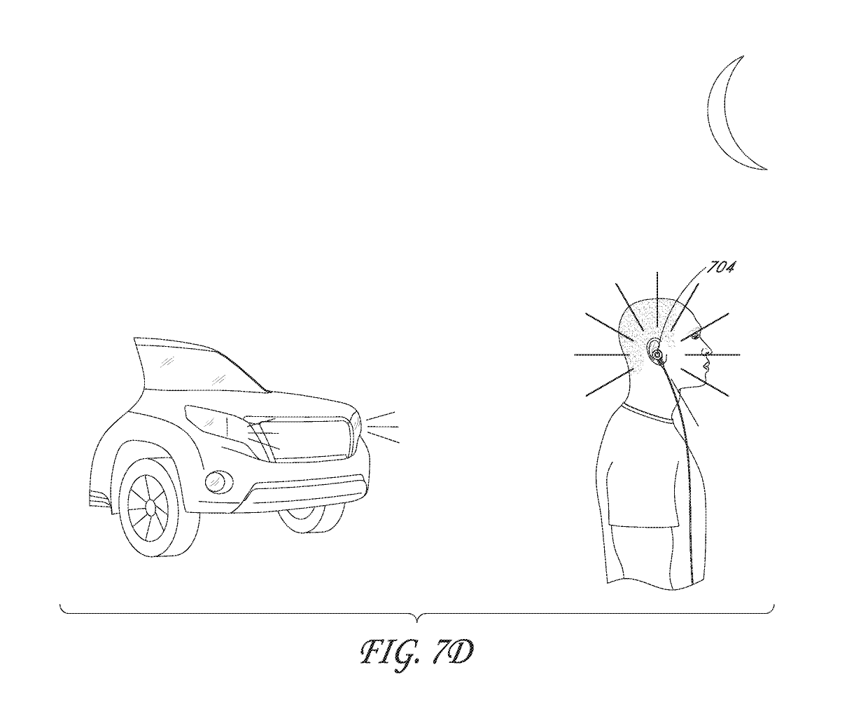

FIGS. 7A-7B illustrate example embodiments where the outer surface 700 of the decorative, protective, and/or functional portion or cap comprises of one or more graphics and/or graphical displays 704. The graphical displays 704 can display graphics to be viewable when a user is wearing his or her earphone device. For example, as shown in FIG. 7A, the one or more graphical displays 704 can comprise one or more text, logos, drawings, lights, videos, and/or photographs as selected by the user. For example, a user can wish to display text and/or a logo of his or her favorite professional and/or amateur sports team, company, club, and/or association. Alternatively, a user can wish to display his or her name, a family member's name, photograph of him or herself, photograph of his or her family, or the like. Such customizable text, logos, drawings, etc. can help the owner to identify the earbud. This can also allow others to identify the identity of the owner when the owner is using the earbud. Also, a user can wish to display his or her role, nickname, or job. In certain embodiments, the coupling portion 702 can comprise of one or more graphics.

FIG. 7A illustrates an example embodiment of the decorative, protective, and/or functional portion where the graphical user interface 704 can change the graphics from a smiley face 704A to a frown face 704B. The graphical user interface can display changing graphics based on certain characteristics, such as characteristics of the individual, extrinsic characteristics, and/or the functioning of the earbud. For example, the graphical display 704 can display a brighter image during the day and a darker image at night, or other extrinsic characteristic. The graphical display 704 can display the name of the song being played or other characteristic of the audio generated by the earbud. The graphical display 704 can display the name of the person using the device or other characteristic of the user. FIG. 7B illustrates an example embodiment of the decorative, protective, and/or functional portion where the graphical user interface 704 displays the time.

In certain embodiments, the decorative, protective, and/or functional portion or cap and/or outer surface thereof can be translucent and/or transparent. In some embodiments, the decorative, protective, and/or functional portion or cap and/or outer surface thereof can comprise an LED, LCD, and/or other display means, as to allow one or more graphical displays to be displayed. For example, the displayed graphics can be configured to change and/or alternate between a select plurality. In certain embodiments, one or more graphical displays 704 and/or lights displayed on the outer surface can be configured to blink, change in intensity, and/or change another parameter, along with the beat and/or other quality of the music being played. For example, one or more graphical displays and/or features thereof being displayed on the outer surface can be configured to change at a speed corresponding to the beats per minute of the music being played by a user via the and/or earphone device. In some embodiments, as shown in FIG. 7B, the display can be configured to display the time.

In some embodiments, the displayed graphics can be configured to be changed, altered, and/or otherwise controlled by a user via a handheld device, such as a smartphone and/or digital music player. In some embodiments, an outer surface 700 can comprise a white board, chalk board, and/or other type of medium that allows a user or other person to write and/or draw. For example, in certain embodiments, a user and/or other person can write his or her own messages onto the outer surface. In some embodiments, the one or more caps can comprise at least one opening and/or at least partially transparent portion that enables a logo or other portion of the earpiece to be seen therethrough. Such an embodiment can be desirable when, for example, a user desires that an existing logo located on the earpiece be shown along with the graphic or other feature shown on the caps.

In some embodiments, the one or more decorative, protective, and/or functional devices can comprise one or more printed circuits. For example, in certain embodiments, a decorative, protective, and/or functional device can comprise one or more circuits adapted to generate one or more graphical displays, as discussed above.

In certain embodiments, the device can comprise one or more buttons, sensor touch buttons, pressure buttons, and/or other user interface components configured to initiate one or more commands when selected by a user. For example, in some embodiments, a user can control the music and/or one or more electronics embedded in the cap via one or more buttons of the cap. More specifically, in certain embodiments, the user can be able to turn the music on or off, increase or decrease the volume, turn on or off a display on the cap, pause, play, fast-forward, rewind, go to a next track, go back to a previous track, or the like via one or more buttons and/or other input means located on the one or more caps. In some embodiments, such input received from a user by the one or more caps can be relayed to one or more electronics of the cap and/or audio source via a printed circuit, wire or cable, and/or wireless connectivity, such as Bluetooth. In certain embodiments, a handheld device can be configured to receive any of the aforementioned commands from a user and relay such to one or more caps. In some embodiments, one or more caps can comprise a power source, such as a rechargeable battery, alkaline battery, lithium battery, and/or the like configured to provide power to electrical functions of the caps (for example, graphical display, button press detection, transmission of wireless control commands over Bluetooth, and/or the like).

In some embodiments, the one or more decorative, protective, and/or functional portion devices comprise a monolithic configuration (for example, one-piece, unitary structure, and/or the like). In other embodiments, one or more portions of the device can be manufactured separately at first and are molded and/or otherwise connected at a later point in time to form the device (or can be combined during manufacturing of some components, such as by using insert molding or other processes). For example, the whole device can all be made of a single type of material in some embodiments. In other embodiments, different portions of the device can each be made of one or more different materials. More specifically, in some embodiments, a portion of the cap 700, coupling portion 702, or any combinations thereof can comprise sound absorbing, sound reflecting, soundproof material, printed circuit(s), LED, LCD, while other portions of the device, such as the cap portion, edge portion, sidewall portion, coupling portion or any combinations thereof can comprise a plastic and/or metallic material for effectively attaching and/or locking the device 112, 114 onto an earpiece portion 102, 104.

FIG. 7C illustrates an example use of the LED feature of the example embodiment. When the user is using earphones at night, the LEDs light up and in some embodiments flicker on and off. This feature can increase the visibility of the user when traveling at night. Because using earphones can impair awareness of surroundings, the increased visibility of the user can increase safety for the user. As shown by FIG. 7C, the entire graphical display 704 of the protective, decorative, and/or sound absorbing device can blink. FIG. 7D illustrates an embodiment of a blinking graphical display to warn others nearby in the evening. As such, the graphical display can provide a safety function to notify others of the individual's presence and/or a communication function to display information to the other individuals.

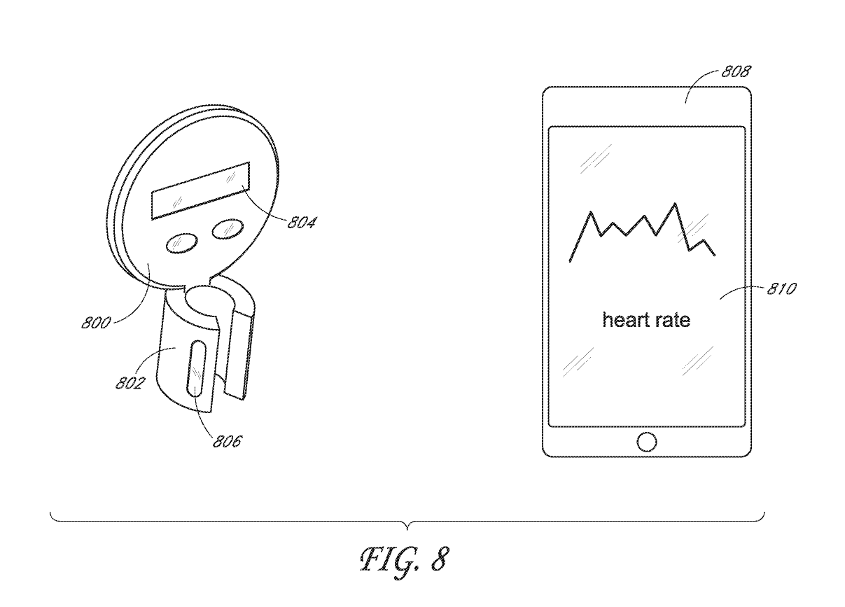

In some embodiments, sensors and/or biosensors can be included. FIG. 8 illustrates an example embodiment where one or more sensors (for example biosensors) are used. For example, a sensor 804 can be attached to the inner surface of the decorative, protective, and/or functional portion or cap 800. Additionally, the sensors and/or biosensors 806 can be attached to the coupling portion 802 as shown in FIG. 8. In some embodiments, the sensors and/or biosensors can be attached to the outer surface of the decorative, protective, and/or functional portion or cap 800. In some embodiments, one or more sensors can be contained inside of the device.

In some embodiments, the sensors and/or biosensors 804, 806 can measure physiological readings of the individual (for example, PPG, heartrate, temperature, and/or steps). The data can be sent to a mobile computing device 808 and/or a server where the measurements can be processed and/or displayed 810 to the user. There can be physiological measurements that are more accurate when taken near the ear than in other locations of the body (for example, than the wrist using a wearable electronic watch with sensors).

### Sound Isolating Features

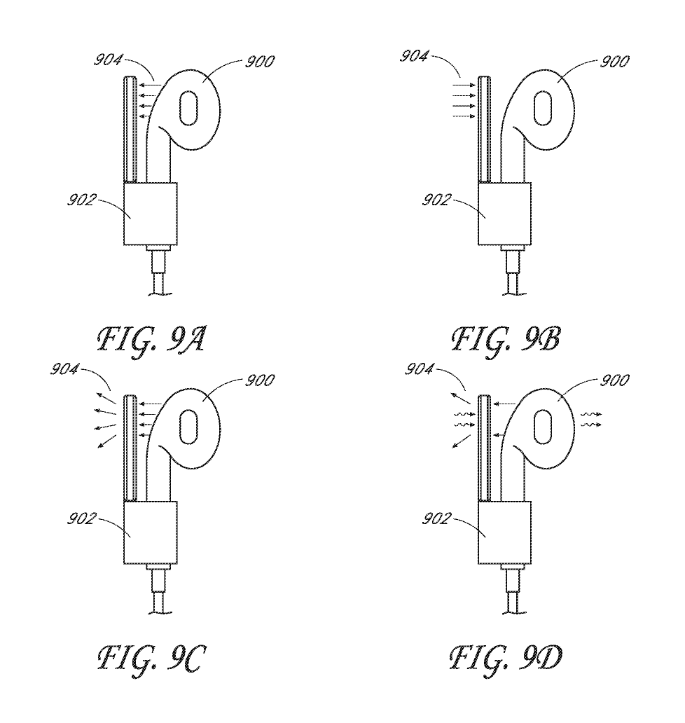

In some embodiments, the decorative, protective, and/or functional portion or cap can have sound isolating features. For example, the decorative, protective, and/or functional portion or cap can comprise of a sound absorbing material that helps to absorb sound that would otherwise be transmitted to third parties. FIGS. 9A-9D illustrate various configurations of the sound absorbing feature. As shown in FIG. 9A, the device 902 is configured to absorb the sound represented by the arrows 904 leaking from the earphones 900. In FIG. 9B, the device 902 is configured to absorb the external sound represented by the arrows 904. In FIG. 9C, the device 902 is configured to let the sound represented by the arrows 904 pass through the device 902. This can be desirable because blocking the sound from the earphones can affect the sound stage and a user may want to preserve the sound stage of an open back earphone. In FIG. 9D, the device 902 is configured to let the sound from the earphones 900 pass through, and at the same time, let the sound played pass out through the device 902 and into the ear. In certain embodiments, a user can desire not to have a sound isolating feature because sound isolation may endanger the user in a perilous environment. In certain embodiments, the user can desire to exhibit the music he or she is playing to the public.

For example, acoustical foams can be used as sound absorbing material. Vinyl barriers can add sound reflective properties to the device. In some embodiments, sound canceling electronics that cancel out ambient noise by actively reducing lower frequencies can be added to the device. In some embodiments, a combination of sound canceling, sound absorbing and sound reflecting techniques can be used.

For purposes of this application, certain aspects, advantages, and novel features of the invention are described herein. It is to be understood that not necessarily all such advantages can be achieved in accordance with any particular embodiment of the invention. Thus, for example, those skilled in the art will recognize that the invention can be embodied or carried out in a manner that achieves one advantage or group of advantages as taught herein without necessarily achieving other advantages as can be taught or suggested herein.

Although several embodiments, examples, and illustrations are disclosed herein, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments can be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

Conditional language, such as, among others, “can,” “could,” “might,” or “can,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

What is claimed is:

1. A monolithic protective cap configured to be removably coupled to an earphone device comprising:
a generally circular cap portion comprising an inner surface, an outer surface, and a side wall portion, wherein the side wall portion comprises a fragment of a generally annular shape, wherein the inner surface extends from at least a fragment of one side of a circumference of the side wall portion and the outer surface extends from at least a fragment of another side of the circumference of the side wall portion, wherein the inner surface and the outer surface comprises a generally flat surface, wherein the inner surface extends from the side wall portion at a first angle measured between the side wall portion and the generally flat surface of the inner surface, wherein the first angle is greater than 45 degrees and less than 135 degrees, wherein the outer surface extends from the side wall portion at a second angle measured between the side wall portion and the generally flat surface of the outer surface, wherein the second angle is greater than 45 degrees and less than 135 degrees, wherein the outer surface further comprises one or more graphics, and wherein the inner surface comprises sound absorbing properties, thereby reducing outside noise from entering the earpiece of the earphone device and further reducing sound from the earphone device from escaping; and
a coupling portion comprising:
a stem portion, wherein the stem portion extends from the cap portion at a third angle measured between the stem portion and the cap portion, wherein the third angle is greater than 135 degrees and less than 225 degrees;
a first arm, wherein the first arm extends from a portion of one side of the stem portion and comprises a fragment of a generally annular shape; and
a second arm, wherein the second arm extends from a portion of another side of the stem portion and comprises a fragment of a generally annular shape, wherein an end of the first arm and an end of the second arm from a gap;
wherein the first and second arms are configured to slide onto a shaft of the earphone device in a general direction from a wire of the earphone device to the shaft of the earphone device and wherein the first and second arms are shaped such that the arms from to the shape of the shaft of the earphone device forming a grip on the earphone device, thereby increasing friction between the first and second arms to allow for coupling between the monolithic protective cap and the earphone device, wherein the first and second arms are configured to detach from the shaft of the earphone device to decrease friction between the monolithic protective cap and the earphone device to allow for easy removal and installation of the cap, and thereby preventing damage to the earpiece and the wire.

2. The monolithic protective cap of claim 1, wherein the inner surface connects to the side wall by an edge portion and the outer surface connects to the side wall by an edge portion, wherein the edge portion and the side wall forms an angle of more than 90 degrees and wherein the edge portion has a width of at most 1 cm.

3. The monolithic protective cap configured to be removably coupled to an earphone device of claim 1, wherein the cap portion further comprises a sound absorbing material.

4. The monolithic protective cap configured to be removably coupled to an earphone device of claim 1, wherein the cap portion further comprises a mendable material.

5. The monolithic protective cap configured to be removably coupled to an earphone device of claim 1, wherein the cap portion further comprises of one or more printed circuit boards.

6. The monolithic protective cap configured to be removably coupled to an earphone device of claim 1, wherein the cap portion further comprises of one or more electronic display modules configured to display one or more graphics.

7. The monolithic protective cap configured to be removably coupled to an earphone device of claim 1, wherein the monolithic protective cap further comprises of one or more sensors configured to measure one or more physiological readings.

8. The monolithic protective cap configured to be removably coupled to an earphone device of claim 1, wherein the monolithic protective cap further comprises of one or more sensors configured to collect one or more biometric data.

9. The monolithic protective cap configured to be removably coupled to an earphone device of claim 1, wherein the monolithic protective cap further comprises of one or more sensors configured to measure characteristics of an audio signal generated by the earphone device.

10. A monolithic cap configured to be removably coupled to an earphone device comprising:
a cap portion comprising an inner surface, an outer surface, and a side wall portion, wherein the inner surface extends from at least a fragment of one side the side wall portion and the outer surface extends from at least a fragment of another side of the side wall portion, wherein the inner surface and the outer surface comprises a generally flat surface, wherein the inner surface extends from the side wall portion at a first angle measured between the side wall portion and the generally flat surface of the inner surface, wherein the first angle is greater than 45 degrees and less than 135 degrees, wherein the outer surface extends from the side wall portion at a second angle measured between the side wall portion and the generally flat surface of the outer surface, wherein the second angle is greater than 45 degrees and less than 135 degrees, wherein the outer surface further comprises one or more graphics, and wherein the inner surface reduces outside noise from entering the earpiece of the earphone device; and
a coupling portion comprising:
a stem portion, wherein the stem portion extends from the cap portion at a third angle measured between the stem portion and the cap portion, wherein the third angle is greater than 135 degrees and less than 225 degrees;
a first arm, wherein the first arm extends from a portion of one side of the stem portion and comprises a fragment of a generally annular shape; and
a second arm, wherein the second arm extends from a portion of another side of the stem portion and comprises a fragment of a generally annular shape, wherein an end of the first arm and an end of the second arm from a gap;
wherein the first and second arms are configured to slide onto a shaft of the earphone device in a general direction from a wire of the earphone device to the shaft of the earphone device and wherein the arms are shaped such that the arms from to the shape of the shaft of the earphone device forming a grip on the earphone device, thereby increasing friction between the first and second arms to allow for coupling between the monolithic cap and the earphone device, wherein the first and second arms are configured to detach from the shaft of the earphone device to decrease friction between the monolithic cap and the earphone device to allow for easy removal and installation of the cap, and thereby preventing damage to the earpiece and the wire.

11. The monolithic cap configured to be removably coupled to an earphone device of claim 10 wherein the cap portion comprises a mendable material.

12. The monolithic cap configured to be removably coupled to an earphone device of claim 11, wherein the cap portion can be shaped to cover the general shape of the earphone device.

13. The monolithic cap configured to be removably coupled to an earphone device of claim 10, wherein a mount extends from the cap portion.

14. The monolithic cap configured to be removably coupled to an earphone device of claim 13, wherein the mount is connected to the cap portion with a hinge.

15. A monolithic cap configured to be removably coupled to an earphone device comprising:
a generally circular cap portion comprising an inner surface, an outer surface, and a side wall portion, wherein the side wall portion comprises a fragment of a generally annular shape, wherein the inner surface extends from at least a fragment of one side of a circumference of the side wall portion and the outer surface extends from at least a fragment of another side of the circumference of the side wall portion, wherein the inner surface and the outer surface comprises a generally flat surface, wherein the inner surface extends from the side wall portion at a first angle measured between the side wall portion and the generally flat surface of the inner surface, wherein the first angle is greater than 45 degrees and less than 135 degrees, wherein the outer surface extends from the side wall portion at a second angle measured between the side wall portion and the generally flat surface of the outer surface, wherein the second angle is greater than 45 degrees and less than 135 degrees, wherein the outer surface further comprises one or more graphics, and wherein the inner surface comprises sound absorbing properties, thereby reducing outside noise from entering the earpiece of the earphone device and further reducing sound from the earphone device from escaping;
a coupling portion extending from a portion of the cap portion, comprising one or more arms, wherein the arms are configured to couple to the earphone device, wherein the one or more arms are configured to removably attach on to an earphone device.

16. A monolithic cap configured to be removably coupled to an earphone device of claim 15 wherein the one or more arms are configured to snap on to a shaft of the earphone device.

17. A monolithic cap configured to be removably coupled to an earphone device of claim 15 wherein the one or more arms are configured to snap on to a wire of the earphone device.

18. A monolithic cap configured to be removably coupled to an earphone device of claim 15 wherein the coupling portion encloses at least a portion of a wire and at least a portion of a shaft of the earphone device.

19. A monolithic cap configured to be removably coupled to an earphone device of claim 15 wherein the coupling portion is made of a mendable material.

20. A monolithic cap configured to be removably coupled to an earphone device of claim 15 wherein the one or more arms comprises of a right arm and a left arm extending from a stem, wherein the left arm and the right arm extend from the stem by a hinge.
